(19) United States
(12) Patent Application Publication
(10) Pub. No.: US 2018/0374026 A1
(43) Pub. Date: Dec. 27, 2018

(54) WORK ASSISTANCE APPARATUS, WORK LEARNING APPARATUS, AND WORK ASSISTANCE SYSTEM

(71) Applicant: Mitsubishi Electric Corporation, Tokyo (JP)

(72) Inventors: Shunya OSAWA, Tokyo (JP); Takeyuki AIKAWA, Tokyo (JP); Yusuke ITANI, Tokyo (JP)

(73) Assignee: Mitsubishi Electric Corporation, Tokyo (JP)

(21) Appl. No.: 16/061,581

(22) PCT Filed: Jan. 8, 2016
(86) PCT No.: PCT/JP2016/050543

§ 371 Date: Jun. 12, 2018

(51) Int. Cl. G06Q 10/06; G06F 3/01; G09B 19/00; G06F 1/16

(52) U.S. Cl. CPC G06Q 10/06398; G06F 1/163; G09B 19/003; G06F 3/013

(57) ABSTRACT

A work assistance apparatus includes a line-of-sight measuring unit configured to measure line-of-sight information about a worker, a line-of-sight movement-direction measuring unit configured to measure the direction of line-of-sight movement along a line-of-sight on the basis of the measurement result acquired by the line-of-sight measuring unit, and to output a measurement quantity of the direction of line-of-sight movement, a skill-level estimator for comparing the measurement quantity with a reference quantity prepared in advance, to estimate a skill level indicating the proficiency level of the worker on the basis of a result of the comparison, and an output controller for causing an information output unit to output work assistance information having descriptions corresponding to the skill level estimated by the skill-level estimator.

### TECHNICAL FIELD

The present invention relates to an information processing technique for assisting in inspection work to be performed by a worker, and more particularly to an information processing technique for providing assistance in inspection work, depending on the proficiency of a worker.

### BACKGROUND ART

In machinery and equipment such as a water treatment plant, a plant facility, and an electric power facility, inspection work for maintenance or quality maintenance is indispensable for the operations of the machinery and equipment. When performing such a type of inspection work, a worker needs to periodically inspect the maintenance state or operating state of the machinery and equipment on the basis of, for example, a work procedure manual or a screen image for a work procedure displayed on an information processing terminal, and record a result of the inspection correctly. Further, when the inspection result shows that there is a defect in the machinery and equipment, the worker must take a measure such as repair of the machinery and equipment or adjustment of the operating state, as needed.

However, in many cases, the instruction contents in the work procedure manual or screen image for a work procedure are common regardless of the skill levels of workers. Therefore, in a case in which the instruction contents are concise contents suitable for workers having a high skill level, a beginner possibly recognizes that the instruction contents are lacking in information or difficult to understand, and then performs inefficient and incorrect inspection work. In contrast, in a case in which the instruction contents are contents suitable for workers having a low skill level, an expert possibly recognizes that the instruction contents are redundant. In this case, the experts' operating efficiency possibly decreases.

Therefore, it is preferable that the instruction contents in the work procedure manual or the screen image for a work procedure be changed to contents corresponding to the skill level of the worker. For example, Patent Literature 1 (Japanese Patent Application Publication No. 2012-234406) discloses a work assistance apparatus that automatically estimates the skill level of a worker and displays instruction contents corresponding to the result of the estimation. The work assistance apparatus measures a distribution of velocity of line-of-sight movement of a worker, and estimates that the worker has a high skill level when a peak of the distribution remarkably appears in a specific velocity range.

### CITATION LIST

### Patent Literature

Patent Literature 1: Japanese Patent Application Publication No. 2012-234406 (paragraphs [0038] to [0052], for example)

### SUMMARY OF INVENTION

### Technical Problem

According to the conventional technique disclosed in Patent Literature 1, when the worker remains stationary, the skill level can be estimated correctly on the basis of measurement values of the distribution of velocity of line-of-sight movement of the worker. However, when the worker performs inspection work while moving, the worker performs not only line-of-sight movement necessary for the inspection work, but also line-of-sight movement needed to move the worker's head or body. The velocity of the line-of-sight movement needed for the movement of the worker becomes a noise component, causing reduction in accuracy of the estimation of the skill level.

In view of the foregoing, it is an object of the present invention to provide a work assistance apparatus, work learning apparatus and work assistance system which make it possible to estimate the skill level of a worker with a high degree of accuracy even when the worker performs inspection work while moving.

### Solution to Problem

According to a first aspect of the present invention, there is provided a work assistance apparatus which includes: a line-of-sight measuring unit configured to measure line-of-sight information about a worker; a line-of-sight movement-direction measuring unit configured to measure a direction of line-of-sight movement on the basis of a measurement result acquired by the line-of-sight measuring unit, thereby to output a measurement quantity of the direction of line-of-sight movement; a skill-level estimator configured to compare the measurement quantity with a reference quantity prepared in advance, and to estimate a skill level indicating a proficiency level of the worker on the basis of a result of the comparison; and an output controller configured to cause an information output unit to output work assistance information having descriptions corresponding to the skill level estimated by the skill-level estimator.

According to a second aspect of the present invention, there is provided a work learning apparatus which includes: an output controller for work learning, configured to cause an information output unit to output display of guidance information that prompts a worker to move a line of sight toward a next work item to be inspected from an inspected work item; a line-of-sight measuring unit for work learning, configured to measure line-of-sight information about the worker in response to the output of display of the guidance information; a line-of-sight movement-direction measuring unit for work learning, configured to measure a direction of line-of-sight movement on the basis of a measurement result acquired by the line-of-sight measuring unit for work learning, thereby to output a measurement quantity of the direction of line-of-sight movement; and a reference data calculator configured to calculate a reference quantity corresponding to the guidance information on the basis of the measurement quantity.

According to a third aspect of the present invention, there is provided a work assistance system which includes: the work assistance apparatus according to the first aspect; and the work learning apparatus according to the second aspect.

### Advantageous Effects of Invention

According to the present invention, because the skill level of a worker is estimated using a measurement quantity of a direction of line-of-sight movement of the worker, the skill level can be estimated with a high degree of accuracy even when the worker performs inspection work while moving. Therefore, by using the result of the estimation, it is possible to provide efficient work assistance depending on the skill level of the worker.

### BRIEF DESCRIPTION OF DRAWINGS

FIG. 1 is a block diagram showing the schematic configuration of a work assistance system of Embodiment 1 according to the present invention;

FIGS. 2A, 2B, and 2C are views of an example of a wearable device equipped with spectacles;

FIG. 3 is a block diagram showing the schematic configuration of a work assistance apparatus according to Embodiment 1;

FIG. 4 is a diagram for explaining an example of the descriptions of work procedure data;

FIG. 5 is a diagram showing an example of display contents using an output data file;

FIG. 6 is a diagram showing another example of the display contents using an output data file;

FIG. 7A is a diagram showing a state in which a worker moves his or her line of sight, and FIG. 7B is a diagram showing an example of guidance information that prompts the movement of his or her line of sight;

FIG. 8 is a diagram showing an example of the contents of a reference data file;

FIG. 9 is a diagram illustrating both a direction shown by the guidance information that prompts movement of a line of sight, and a direction of line-of-sight movement;

FIG. 10 is a flow chart showing an example of the procedure of work assistance processing according to Embodiment 1;

FIG. 11 is a flow chart showing an example of the procedure of a skill-level estimation operation in the work assistance processing according to Embodiment 1;

FIG. 12 is a block diagram showing the schematic configuration of a contents-compilation apparatus according to Embodiment 1;

FIG. 13 is a flow chart showing an example of the procedure of output data file generating processing carried out by the contents-compilation apparatus;

FIG. 14 is a block diagram showing the schematic configuration of a work learning apparatus according to Embodiment 1;

FIG. 15 is a flow chart showing an example of the procedure of work learning processing carried out by the work learning apparatus;

FIG. 16 is a flow chart showing an example of the procedure of a reference data calculation operation in the work learning processing according to Embodiment 1;

FIG. 17 is a block diagram showing the schematic configuration of an information processing device which is an example of the hardware configuration of the work assistance apparatus or the work learning apparatus; and

FIG. 18 is a block diagram showing the schematic configuration of an information processing device which is another example of the hardware configuration of the work assistance apparatus or the work learning apparatus.

### DESCRIPTION OF EMBODIMENTS

Hereafter, embodiments according to the present invention will be explained in detail with reference to the drawings. It is assumed that components denoted by the same reference numerals in the whole of the drawings have the same configurations and the same functions.

### Embodiment 1

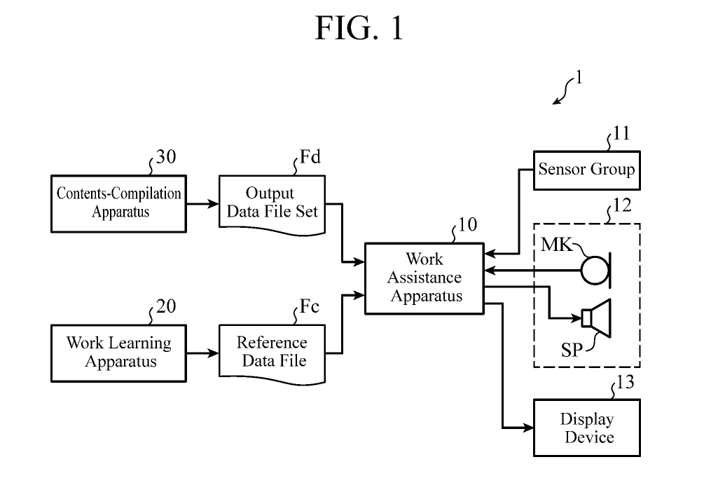

FIG. 1 is a block diagram showing the schematic configuration of a work assistance system 1 of Embodiment 1 according to the present invention. The work assistance system 1 includes a work assistance apparatus 10 that carries out work assistance processing of assisting in inspection work for either maintenance of machinery and equipment or quality maintenance, a work learning apparatus 20 that supplies a reference data file Fc used for the work assistance processing to the work assistance apparatus 10, and a contents-compilation apparatus 30 that supplies an output data file set Fd including work assistance information to the work assistance apparatus 10. The work assistance system further includes a sensor group 11, a sound input/output unit 12, and a display device 13.

The sound input/output unit 12 is comprised of a microphone MK disposed as a sound input unit that converts an acoustic wave into an electric signal, and a speaker SP disposed as a sound output unit that outputs an acoustic wave to space. In the present embodiment, the sensor group 11, the sound input/output unit 12, and the display device 13 construct a wearable device which can be attached to the head or body of a worker.

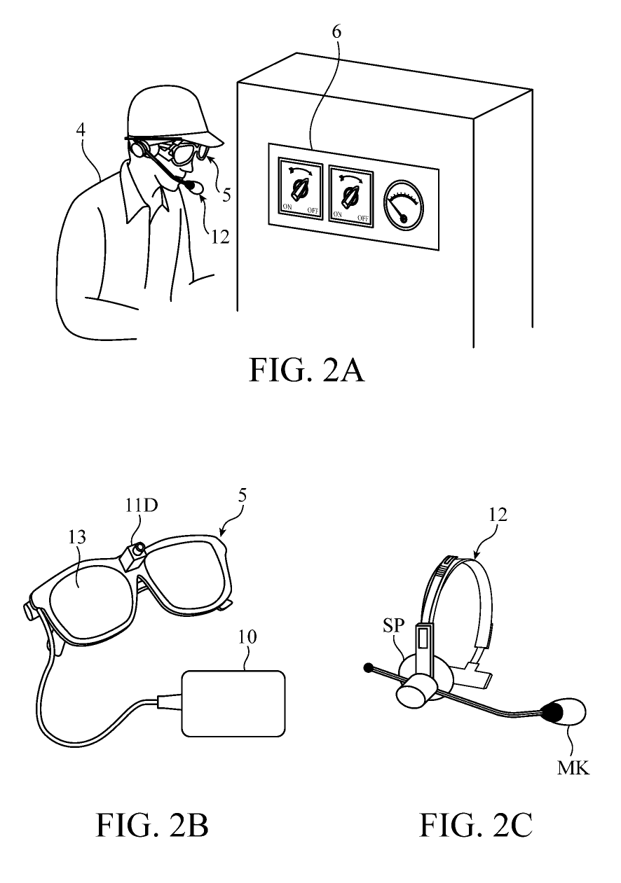

FIGS. 2A, 2B, and 2C are views of an example of a wearable device 5 equipped with spectacles. FIG. 2A is a diagram showing a state in which the wearable device 5 equipped with spectacles and the sound input/output unit (head set) 12 are attached to the head of a worker 4 in such a way that the wearable device equipped with spectacles and the sound input/output unit can be freely attached and detached. The worker 4 can visually perceive light passing through the eyeglass portions of the wearable device 5 equipped with spectacles, and recognize a work target 6.

Further, FIG. 2B is a diagram illustrating the appearance of the wearable device 5 equipped with spectacles and the work assistance apparatus 10, and FIG. 2C is a diagram illustrating the appearance of the sound input/output unit 12. As shown in FIG. 2B, the wearable device 5 equipped with spectacles has the display device 13 that constructs a light transmission type HMD (Head-Mounted Display), and a front-image sensor 11D. The wearable device equipped with spectacles further has an image sensor for line-of-sight detection, a sensor for position detection, and a direction sensor which are not illustrated in the figure. The wearable device 5 equipped with spectacles is connected to the work assistance apparatus 10 via a cable. The image sensor for line-of-sight detection, the sensor for position detection, and the direction sensor will be mentioned later.

The front-image sensor 11D shown in FIG. 2B is comprised of a solid state image sensor such as a CCD image sensor or a CMOS image sensor. The front-image sensor 11D electrically detects an optical image showing the work target 6 located in front of the worker 4, to generate a front image signal, and outputs the front image signal to the work assistance apparatus 10. The display device 13 equipped with spectacles projects a digital image on augmented reality (AR) space, the digital image being generated by the work assistance apparatus 10, onto an inner surface of the eyeglass portions, thereby making it possible for the worker 4 to visually recognize the projected image.

A skill level in the present embodiment is a value indicating the proficiency level in inspection work that is performed by a worker. Referring to FIG. 1, the output data file set Fd is comprised of plural output data files respectively corresponding to plural skill levels (e.g., an output data file showing either display contents or sound output contents for beginners, and an output data file showing either display contents or sound output contents for experts). The contents-compilation apparatus 30 is used in order for a compiler to generate the output data file set Fd in advance. On the other hand, the reference data file Fc includes data showing a reference quantity of the direction of line-of-sight movement of a worker, and data showing a reference value of a timing at which a line-of-sight movement of a worker starts. The work learning apparatus 20 has a function of automatically generating the reference data file Fc by learning pieces of actual inspection work performed by plural workers including beginners and experts.

The work assistance apparatus 10 estimates the skill level of a worker by using the reference data file Fc. Further, the work assistance apparatus 10 supplies work assistance information having descriptions corresponding to the skill level to the display device 13, the speaker SP, or both these display device 13 and speaker SP, by using the output data file set Fd. As a result, the worker can recognize the work assistance information visually, auditorily, or visually and auditorily. An information output unit that outputs work assistance information is comprised of the speaker SP and the display device 13.

Work performed using the work assistance system 1 of the present embodiment is grouped into on-line work (i.e., inspection work) performed at an inspection site, and the off-line work performed prior to the on-line work. The work learning apparatus 20 and the contents-compilation apparatus 30 are used for off-line work, and the work assistance apparatus 10 is used for the on-line work.

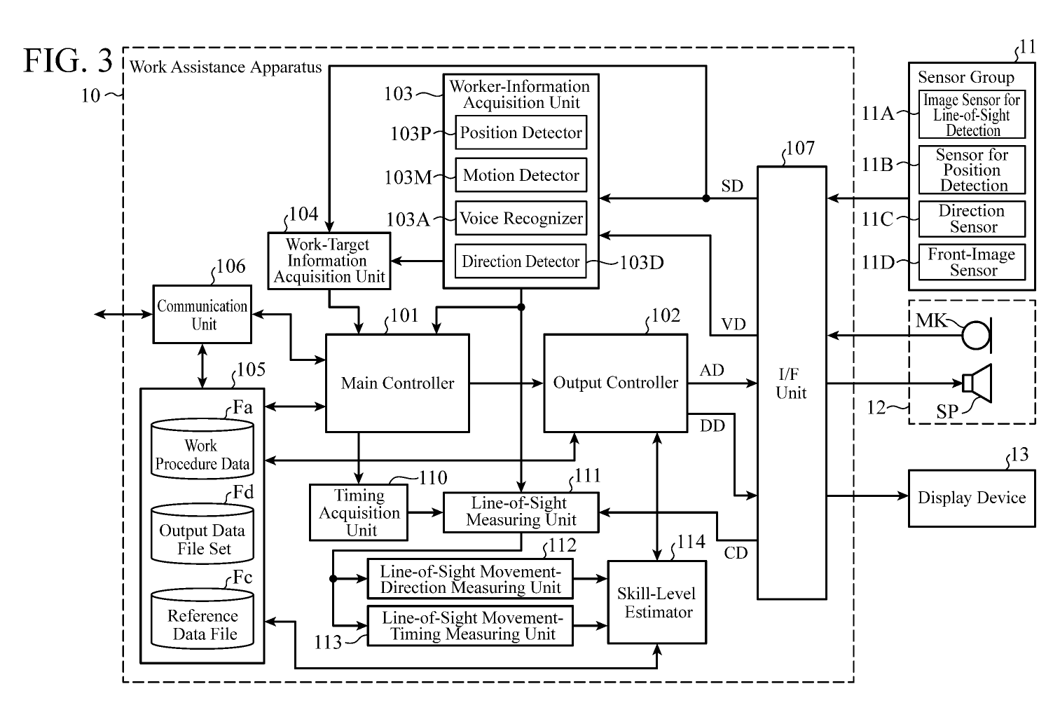

First, the work assistance apparatus 10 will be explained. FIG. 3 is a block diagram showing the schematic configuration of the work assistance apparatus 10 according to Embodiment 1.

As shown in FIG. 3, the work assistance apparatus 10 includes a main controller 101, an output controller 102, a worker-information acquisition unit 103, a work-target information acquisition unit 104, a storage medium 105, a communication unit 106, and an interface unit (I/F unit) 107. The work assistance apparatus 10 further includes, as components for the estimation of a skill level, a timing acquisition unit 110, a line-of-sight measuring unit 111, a line-of-sight movement-direction measuring unit 112, a line-of-sight movement-timing measuring unit 113, and a skill level estimator 114.

Work procedure data Fa are stored in the storage medium 105 together with the above-mentioned output data file set Fd and the above-mentioned reference data file Fc. The main controller 101 controls the contents of the output of the output controller 102 in accordance with the procedure defined by the work procedure data Fa. The communication unit 106 can communicate with the work learning apparatus 20 to acquire the reference data file Fc from the work learning apparatus 20, and store the reference data file Fc in the storage medium 105. The communication unit 106 can also communicate with the contents-compilation apparatus 30 to acquire the output data file set Fd from the contents-compilation apparatus 30, and store the output data file set Fd in the storage medium 105.

For example, at a location where a communication network environment exists, the work learning apparatus 20 and the contents-compilation apparatus 30 can store the output data file set Fd and the reference data file Fc in an information distribution server. The communication unit 106 of the work assistance apparatus 10 can transmit a distribution request to the information distribution server to acquire the output data file set Fd and the reference data file Fc. As an alternative, in a case in which the storage medium 105 is configured as a storage medium which can be freely attached and detached, the reference data file Fc can be transferred from the work learning apparatus 20 to the work assistance apparatus 10 via the storage medium 105, and the output data file set Fd can be transferred from the contents-compilation apparatus 30 to the work assistance apparatus 10 via the storage medium 105.

On the other hand, the I/F unit 107 is configured in such a way as to carry out transmission and reception of data among the sensor group 11, the sound input/output unit 12, and the display device 13. Although the I/F unit 107 of the present embodiment is connected to the sensor group 11, the sound input/output unit 12, and the display device 13 via cables, as shown in FIG. 2B, the present embodiment is not limited to this example, and the I/F unit 107 can be connected to the sensor group 11, the sound input/output unit 12, and the display device 13 by using a wireless communication technique.

The sensor group 11 includes an image sensor 11A for line-of-sight detection, a sensor 11B for position detection, a direction sensor 11C, and the front-image sensor 11D. The image sensor 11A for line-of-sight detection takes an image of an eyeball of a worker to generate image data showing the eyeball, and supplies the image data CD to the line-of-sight measuring unit 111 via the I/F unit 107. The line-of-sight measuring unit 111 can analyze the image showing the eyeball to measure the line of sight of the worker in real time.

As the sensor 11B for position detection, for example, a GNSS (Global Navigation Satellite System) sensor such as a GPS (Global Positioning System) sensor, an electric wave sensor that detects an electric wave emitted by a wireless LAN base station, or an RFID (Radio Frequency IDentification) sensor is provided. However, the sensor 11B for position detection is not particularly limited to such a sensor as long as the sensor for position detection is used for the detection of the position of a worker and the position of a work target. Further, the direction sensor 11C is used for the detection of the face direction of a worker. For example, the direction sensor can be comprised of a gyro sensor and an acceleration sensor. The front-image sensor 11D takes an image of an object located in front of a worker to generate a digital image. The front-image sensor 11D is comprised of a solid state image sensor such as a CCD image sensor or a CMOS image sensor.

Sensor data SD that consist of the outputs of the sensor 11B for position detection, the direction sensor 11C, and the front-image sensor 11D are supplied to the worker- information acquisition unit 103 and the work-targetinformation acquisition unit 104 via the I/F unit 107.

The microphone MK detects an input acoustic wave such as a voice, and supplies input voice data VD which is a result of the detection to the worker-information acquisition unit 103 via the I/F unit 107. The speaker SP converts outputted acoustic data AD input thereto, via the I/F unit 107, from the output controller 102 into an acoustic wave, and outputs the acoustic wave. On the other hand, the display device 13 has a function of converting display data DD input thereto, via the I/F unit 107, from the output controller 102 into a display image, and outputting the display image.

The worker-information acquisition unit 103 includes a position detector 103P that detects a current position of a worker, a motion detector 103M that detects a motion pattern of the worker, a voice recognizer 103A that recognizes a specific voice pattern, and a direction detector 103D that detects a direction in which the face of the worker is facing (simply referred to as “the face direction of the worker” hereafter). Worker information includes at least one of the current position, the face direction, the motion pattern, and the voice pattern of a worker. The worker information is supplied to the main controller 101. Further, results of the detection of the face direction and the current position of a worker are supplied also to the work-target information acquisition unit 104.

The position detector 103P detects the current position of a worker in real time on the basis of the detection output of the sensor 11B for position detection. For example, when a worker is outside, the current position of the worker can be detected using the above-mentioned GNSS sensor. In contrast, when a worker is inside, the current position of the worker (e.g., a current position defined on a per-building basis, on a per-floor basis, or on a per-room basis) can be detected using either the detection output of the above-mentioned electric wave sensor or the detection output of the above-mentioned RFID sensor. The position detector 103P can acquire information about the current position of a worker from a management system disposed separately such as an entering and leaving control system. The direction detector 103D can detect the face direction of a worker in real time on the basis of the detection output of the direction sensor 11C.

The motion detector 103M analyzes moving image data outputted from the front-image sensor 11D to detect a specific motion pattern of a part (e.g., a hand) of the body of a worker. When a worker moves a part of his or her body with a specific motion pattern (e.g., a motion pattern of moving an index finger up and down), the motion detector 103M can detect the motion pattern by performing a moving image analysis. The motion detector 103M can detect a motion pattern by using not only the moving image data, but also distance information (depth information) acquired by a distance sensor (not illustrated). The distance sensor has a function of detecting the distance to each part of the body surface of a worker by using a well-known projector camera method or a well-known TOF (Time Of Flight) method. The voice recognizer 103A also analyzes the input voice data VD to recognize a voice of a worker, and, when the recognized voice matches a registered voice (e.g., “Inspection has been completed” or “Next inspection”), outputs a result of the recognition. The voice recognition method is not limited particularly to this example, and a well-known voice recognition technique can be used.

On the other hand, the work-target information acquisition unit 104 acquires the results of the detection of the current position and the face direction of a worker from the worker-information acquisition unit 103, and also acquires the front image signal from the sensor data SD. The work-target information acquisition unit 104 can recognize a candidate for a work target existing ahead of the line of sight of the worker by analyzing the front image signal by using the detection results, and can also recognize candidates for a work item in the work target and output results of the recognition of the candidates to the main controller 101. The work-target information acquisition unit 104 can recognize both a candidate for a work target existing at a specific position in a direction which the face of the worker is facing, and candidates for a work item from the front image signal, by using, for example, a well-known pattern matching method.

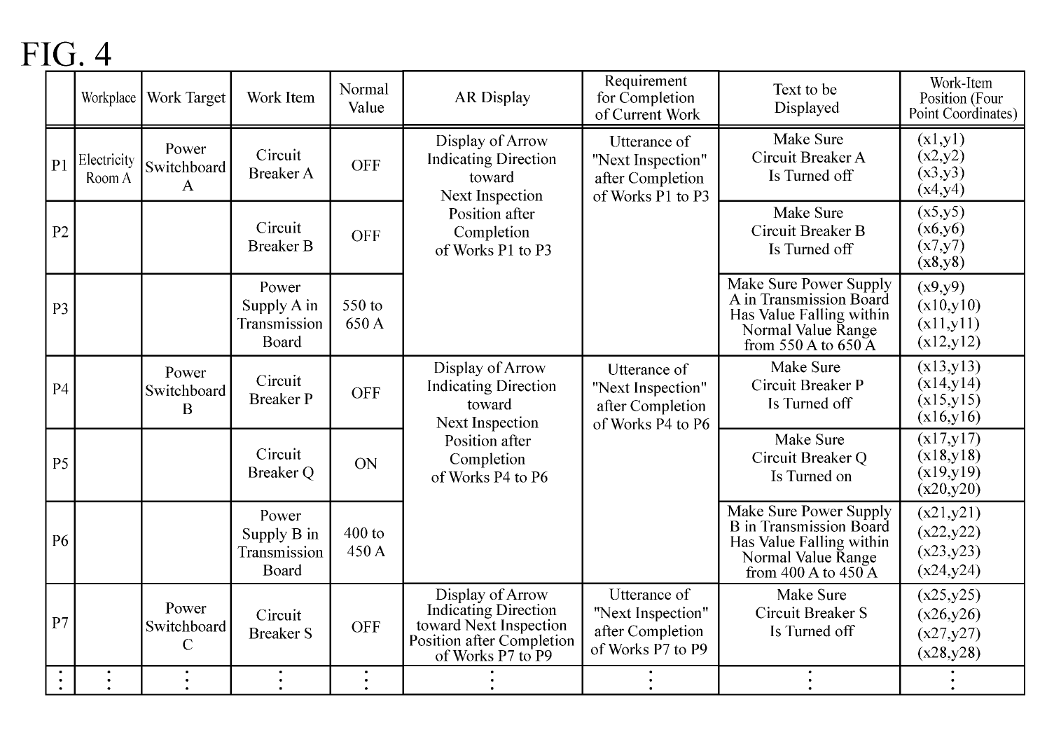

The main controller 101 controls the contents of the output of the output controller 102 in accordance with the procedure defined by the work procedure data Fa stored in the storage medium 105. FIG. 4 is a diagram for explaining an example of the descriptions of the work procedure data Fa. In the example shown in FIG. 4, a combination of “workplace”, “work target”, “work item”, “normal value”, “AR display”, “requirement for completion of current work”, “text to be displayed”, and “work item position (four point coordinates)” is defined for each procedure ID (procedure identifier). “Workplace” defines a location where a worker should perform inspection work, “work target” defines an object which is a work target, such as a power switchboard, which is arranged at the location, “work item” defines a work item which is an inspection object in the work target, and “normal value” defines a numerical value or a symbol at a time when the operating state of the work item is normal. Further, default display information about the work item specified by each procedure ID is defined in “text to be displayed” shown in FIG. 4.

Further, position information for specifying an arrangement range which is occupied by a work item in each work target is defined in “work item position (four point coordinates)” shown in FIG. 4. In the example shown in FIG. 4, a combination of four two-dimensional coordinates which respectively specify the positions of four points in each work item is defined. The main controller 101 can recognize a work item from among the work item candidates recognized by the work-target information acquisition unit 104, by using the position information. The method of specifying the arrangement range of each work item is not limited to the one of using a combination of two-dimensional coordinates shown in FIG. 4. For example, the arrangement position of each work item can be specified by using a combination of three-dimensional coordinates.

Further, “requirement for completion of current work” shown in FIG. 4 defines a requirement to complete the inspection work on the current work target or work item. Concretely, “requirement for completion of current work” defines information which a worker should input via voice. For example, as to P1 to P3, it is defined as the requirement to complete work on a work target (power switchboard A) that a worker should utter “Next inspection.” The voice recognizer 103A can recognize the contents of the utterance.

As the requirement to complete inspection work, a specific motion pattern of a part of a body can be defined. The motion detector 103M can recognize such a motion pattern. As an alternative, the completion of response input of an inspection result can be defined as the requirement to complete inspection work.

Display information on an augmented reality (AR) space which should be displayed after the completion of inspection work is defined in “AR display” shown in FIG. 4.

For example, as to P1 to P3, it is defined that after the completion of work on each of the work items specified by the procedure IDs (a circuit breaker A, a circuit breaker B, and a power supply A in a transmission board), the direction of the next inspection position (the position of the next work item to be inspected) is indicated by an arrow. In this case, the “arrow” represents the display information.

The output controller 102 shown in FIG. 3 acquires an output data file corresponding to the skill level estimated by the skill-level estimator 114 from the output data file set Fd in accordance with control performed by the main controller 101. The output controller 102 then supplies the work assistance information having descriptions shown by the output data file to the speaker SP, the display device 13, or both these speaker and display device via the I/F unit 107.

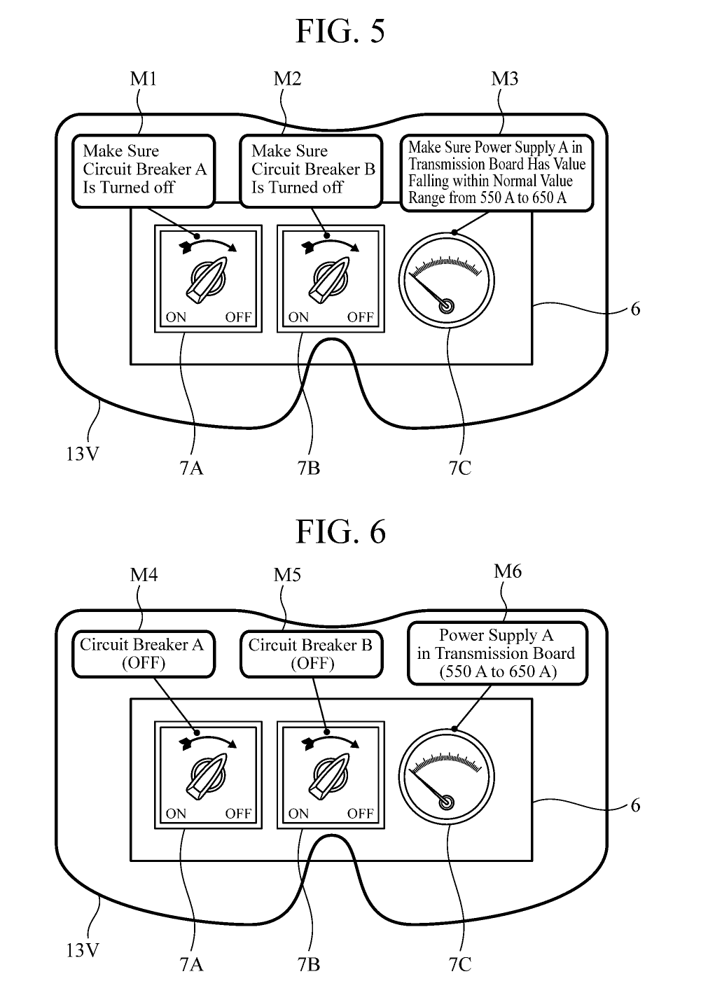

FIG. 5 is a diagram showing an example of the work assistance information using an output data file for beginners which corresponds to the lowest skill level. As shown in FIG. 5, a worker visually recognizes an image showing the work target 6 on real space via the eyeglass portions 13V of the display device 13, while he or she can visually recognize image messages M1, M2, and M3 on the AR space which are projected onto the inner surface of the eyeglass portions 13V. The work target 6 has three work items 7A, 7B, and 7C. The image messages M1, M2, and M3 indicate the contents of inspections on these three work items 7A, 7B, and 7C, respectively.

In contrast, FIG. 6 is a diagram showing an example of the work assistance information using an output data file for experts which corresponds to a relatively high skill level. As shown in FIG. 6, a worker visually recognizes an image showing the work target 6 on real space via the eyeglass portions 13V, while he or she can visually recognize image messages M4, M5, and M6 on the AR space which are projected onto the inner surface of the eyeglass portions 13V. These image message M4, M5, and M6 indicate descriptions which are provided by simplifying the descriptions of the image messages M1, M2, and M3 shown in FIG. 5, respectively.

When the requirement for completion of current work mentioned above (FIG. 4) is satisfied and, as a result, the inspection work is completed, the output controller 102 outputs, as display data DD, guidance information that prompts movement of the line of sight toward the next work item to be inspected from the inspected work item, in accordance with control of the main controller 101. In the case of the example shown in FIG. 4, as to each of the work items (the circuit breaker A, the circuit breaker B, and the power supply A in a transmission board) corresponding to P1 to P3, the inspection work is completed when the worker utters “Next inspection.” After that, the output controller 102 supplies, as guidance information, display data DD having descriptions defined by “AR display” (an arrow indicating the direction of the position of the next inspection) to the display device 13.

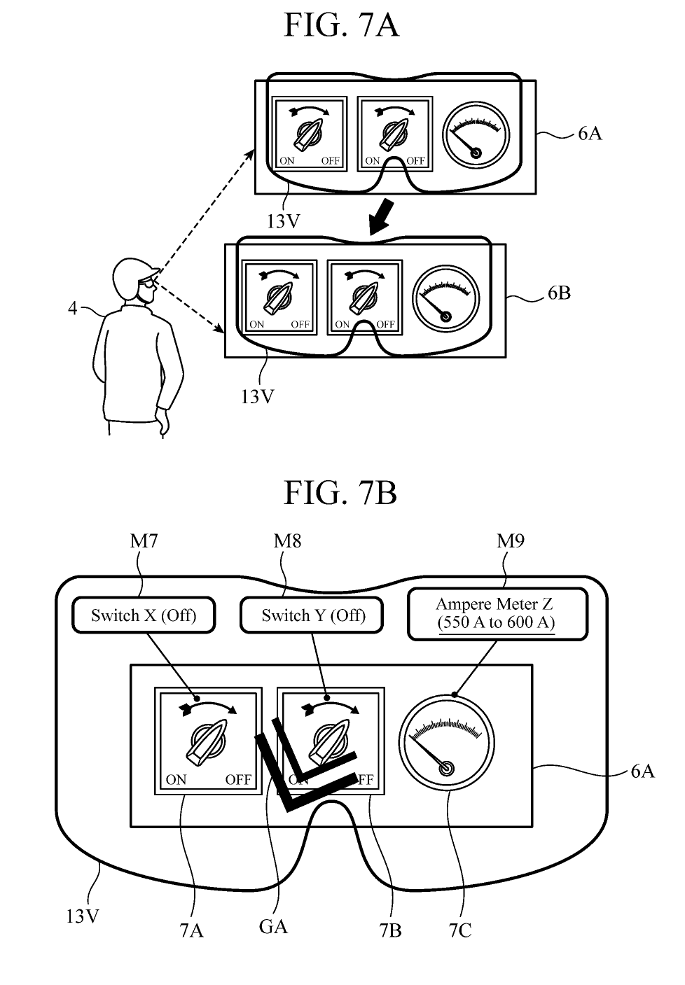

FIG. 7A is a diagram schematically showing a situation in which a worker 4 moves the line of sight toward work items in a work target 6B from work items in a work target 6A, and FIG. 7B is a diagram showing an example of guidance information GA showing an arrow symbol to prompt the movement of the line of sight. As shown in FIG. 7B, the output controller 102 displays image messages M7, M8, and M9 about three work items during inspection work, and displays the guidance information GA in response to the completion of the inspection work.

The main controller 101 notifies the timing acquisition unit 110 of a change timing in response to the display output of the above-mentioned guidance information. For example, the main controller 101 can notify the timing acquisition unit 110 of a change timing immediately after the display output of the above-mentioned guidance information is performed by the output controller 102. The timing acquisition unit 110 causes the line-of-sight measuring unit 111 to start a measurement of line-of-sight information, in response to the notification. The line-of-sight measuring unit 111 can analyze the image data CD acquired by the image sensor 11A for line-of-sight detection to measure line-of-sight information about a worker (including line-of-sight coordinates and time information) in real time. Data showing results of the measurement are supplied to the line-of-sight movement-direction measuring unit 112 and the line-of-sight movement-timing measuring unit 113. The line-of-sight movement-direction measuring unit 112 uses the line-of-sight coordinates included in the line-of-sight information, and the line-of-sight movement-timing measuring unit 113 uses the time information included in the line-of-sight information.

As the method of measuring a line of sight, a well-known image analysis method such as a corneal reflection method can be used. In the case of using the corneal reflection method, for example, the line-of-sight measuring unit 111 analyzes the motion of a pupil which appears in an eyeball image taken by the image sensor for line-of-sight detection on the basis of the eyeball image, to estimate the coordinates of the pupil center and the position coordinates of a corneal reflection image (the position coordinates of an optical image called a Purkinje image). The line-of-sight measuring unit 111 can calculate a sight line vector showing a line-of-sight direction on three-dimensional virtual space on the basis of both the coordinates of the pupil center and the position coordinates of the corneal reflection image. The line-of-sight measuring unit 111 can calculate line-of-sight coordinates on a two-dimensional image coordinates system, the line-of-sight coordinates showing the position at which a worker gazes, on the basis of the sight line vector. A line-of-sight measurement algorithm using such a corneal reflection method is disclosed in, for example, PCT International Application Publication No. 2012/137801.

The line-of-sight measuring unit 111 can measure line-of-sight information about a worker by using only the image data CD including an eyeball image of the worker. As an alternative, the line-of-sight measuring unit can measure line-of-sight information by using the face direction detected by the direction detector 103D in addition to the image data CD. As a result, a measurement of line-of-sight information with a higher degree of reliability can be carried out.

The configuration of the line-of-sight measuring unit 111 can be modified in such a way that the line-of-sight measuring unit measures line-of-sight information on the basis of only the face direction detected by the direction detector 103D. In this case, the line-of-sight direction is estimated from the face direction. Therefore, because it is not necessary to use both a sophisticated sensing technique for specifying the position of the line of sight on the basis of the image data CD, and the image sensor 11A for line-of-sight detection, the configuration of the sensor group 11 and the configuration of the line-of-sight measuring unit 111 can be implemented at a low cost.

The line-of-sight movement-direction measuring unit 112 measures the direction of line-of-sight movement of a worker immediately after the display of the guidance information on the basis of a measurement result (line-of-sight coordinates) acquired by the line-of-sight measuring unit 111, and outputs a measurement quantity Dm of the direction of line-of-sight movement to the skill-level estimator 114. The measurement quantity Dm can be calculated as, for example, an angle or a vector quantity. In parallel, the line-of-sight movement-timing measuring unit 113 measures a timing at which a line-of-sight movement of the worker immediately after the display of the guidance information starts on the basis of a measurement result acquired by the line-of-sight measuring unit 111, and outputs a measurement value (time information) Tm of the timing to the skill-level estimator 114.

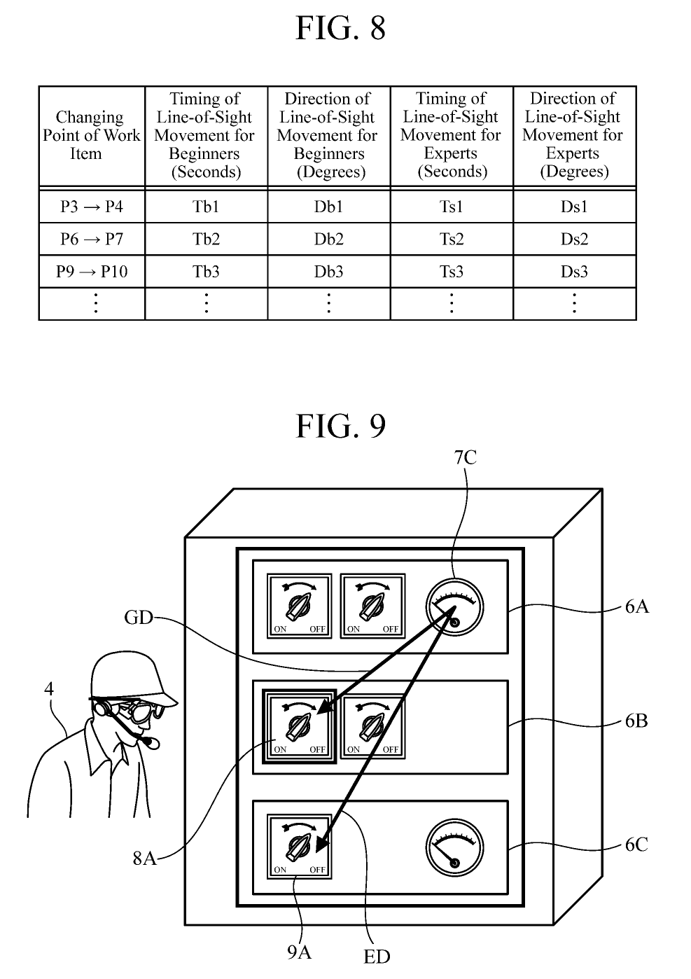

The skill-level estimator 114 accesses the storage medium 105 to acquire the reference data file Fc. Both data indicating a reference quantity of the direction (referred to as a “directional reference quantity” hereafter) of line-of-sight movement, and data indicating a reference value of the timing (referred to as a “timing reference value” hereafter) at which the line-of-sight movement of a worker starts are included in the reference data file Fc. A plurality of combinations of the directional reference quantity and the timing reference value is prepared for each point at which to change from a work item to another work item, the number of combinations being equal to the number of skill levels which can be estimated. FIG. 8 is a diagram showing an example of the contents of the reference data file Fc having two types of reference data sets including a reference data set for beginners and a reference data set for experts. In the example shown in FIG. 8, a point at which to change from a work item to another work item, a reference value (unit: second) of the timing of line-of-sight movement for beginners, a reference quantity (unit: angle (degrees)) of the direction of line-of-sight movement for beginners, a reference value (unit: second) of the timing of line-of-sight movement for experts, and a reference quantity (unit: angle (degrees)) of the direction of line-of-sight movement for experts are shown. For example, when the work procedure is changed from P3 to P4, timing reference values Tb1 and Ts1 and directional reference quantities Db1 and Ds1 are used for the estimation of a skill level.

FIG. 9 is a diagram schematically showing an example of a line-of-sight movement of a worker 4 immediately after the display of the guidance information. In the example shown in FIG. 9, because a work item 8A in a work target 6B is set as the next work item to be inspected after the inspection work on a work item 7C in a work target 6A is completed, the work item 8A exists ahead of the direction GD of an arrow shown by the guidance information. However, the line of sight of the worker 4 has moved to a work item 9A in a work target 6C. The measurement quantity Dm of the direction ED of the line-of-sight movement of the worker 4 should just be calculated as a relative quantity which is defined relative to the arrow direction GD. At this time, because the worker has full knowledge of the work procedure when the worker is an expert, the difference between the arrow direction GD pointing to the position of the next work item 8A to be inspected and the direction ED of line-of-sight movement is small. Further, when the worker is an expert, the timing at which a line-of-sight movement to the next work item 8A starts after the moment that the guidance information is displayed is early. In other words, when the worker is an expert, the time difference between the moment and the timing at which a line-of-sight movement starts is small.

The skill-level estimator 114 can estimate the skill level on the basis of a combination of a comparison result which is acquired by comparing the measurement quantity Dm with the directional reference quantity, and a comparison result which is acquired by comparing the measurement value Tm with the timing reference value. Concretely, the skill-level estimator 114 selects a combination which is most similar to a combination of the actual measurement quantity Dm and the actual measurement value Tm from among the combinations of the directional reference quantity and the timing reference value, and outputs, as a result of the estimation, a similarity corresponding to the combination selected thereby. The skill-level estimator can alternatively estimate the skill level on the basis of only either the comparison result which is acquired by comparing the measurement quantity Dm with the directional reference quantity, or the comparison result which is acquired by comparing the measurement value Tm with the reference value. A concrete example of the method of estimating the skill level will be mentioned later.

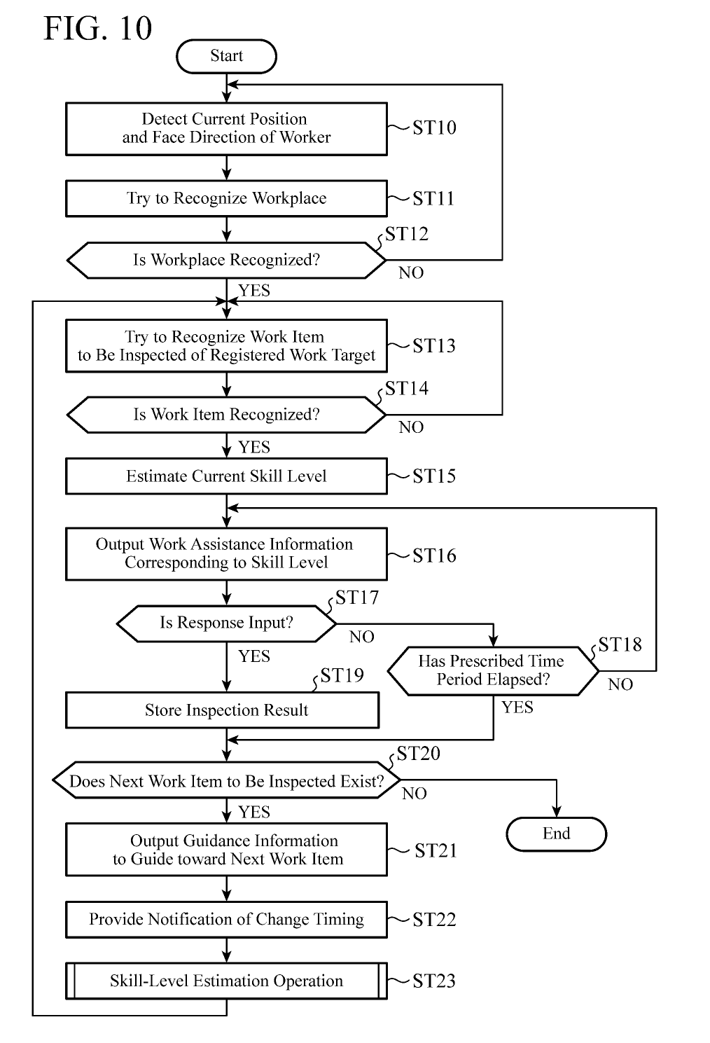

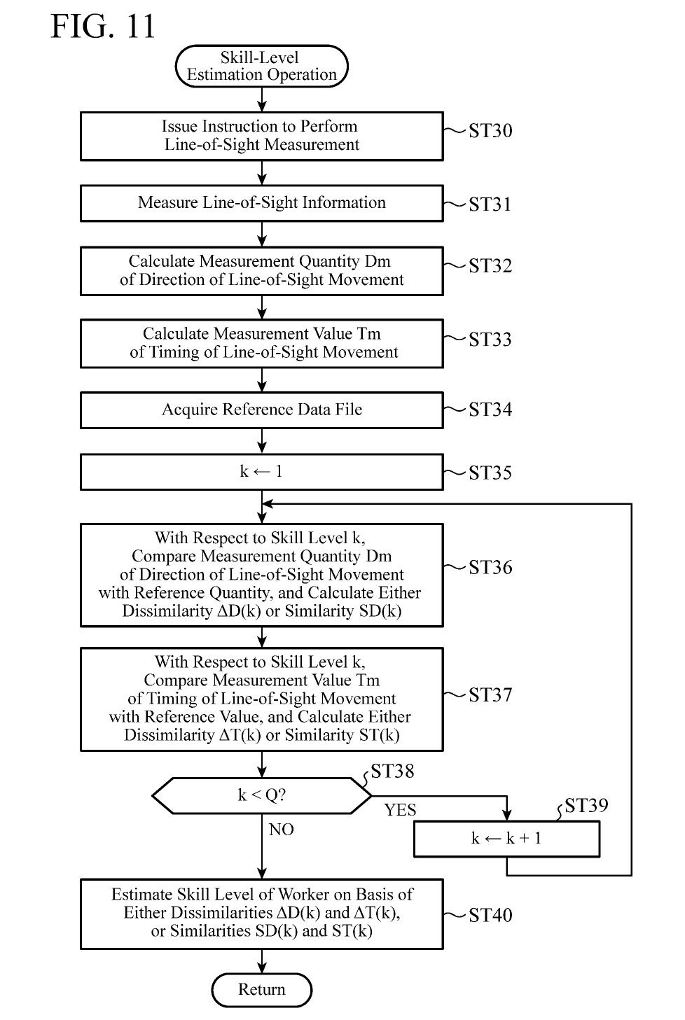

Next, the operations of the work assistance apparatus 10 described above will be explained with reference to FIGS. 10 and 11. FIG. 10 is a flow chart showing an example of the procedure of the work assistance processing carried out by the work assistance apparatus 10, and FIG. 11 is a flow chart showing an example of the procedure of a skill level estimation operation (step ST23) in the work assistance processing shown in FIG. 10.

Referring to FIG. 10, the worker-information acquisition unit 103 detects the current position and the face direction of a worker, as mentioned above, and outputs results of the detection to the main controller 101 (step ST10). The main controller 101 tries to recognize a workplace on the basis of the detection results (step ST11). More specifically, the main controller 101 determines whether the current position of the worker corresponds to a position in a workplace registered in the work procedure data Fa. As a result, when no workplace is recognized (NO in step ST12), the processing returns to step ST10.

In contrast, when a workplace is recognized (YES in step ST12), the main controller 101 tries to recognize a work item to be inspected of a work target registered in the work procedure data Fa by using a recognition result acquired by the work-target information acquisition unit 104 (step ST13). As a result, when no work item to be inspected is recognized (NO in step ST14), the processing returns to step ST13. The flow chart shown in FIG. 10 can be modified in such a way that the processing returns to step ST10 when the state in which no work item to be inspected is recognized lasts a prescribed time period.

When a work item to be inspected is recognized (YES in step ST14), the skill-level estimator 114 estimates the current skill level (step ST15). To be more specific, the output controller 102 makes a request of the skill-level estimator 114 to estimate the skill level, in accordance with control performed by the main controller 101, and the skill-level estimator 114 estimates the current skill level in response to the request.

Specifically, in a case in which skill levels 1 to Q on a Q-level scale can be estimated (Q is an integer equal to or greater than 2), for example, the skill-level estimator 114 can estimate that the most frequent skill level among N most recent consecutive results (N is an integer equal to or greater than 2) of the skill-level estimation is the current skill level. In this case, when the number of times that the skill level j is estimated is equal to the number of times that the skill level i is estimated (i≠j), it can be estimated that a lower-proficiency one of those two skill levels j and i is the current skill level.

As an alternative, in a case in which only two skill levels including the skill level 1 for beginners and the skill level 2 for experts are prepared, the skill-level estimator 114 can estimate that the skill level 2 is the current skill level, when the number of times that the skill level 2 is estimated is equal to or greater than M (M is a positive integer; M≤N) among N most recent consecutive results of the skill-level estimation. In contrast, when the number of times that the skill level 2 is estimated is less than M, the skill-level estimator 114 can estimate that the skill level 1 is the current skill level.

Next, the output controller 102 accesses the storage medium 105 to select an output data file corresponding to the skill level from the output data file set Fd, and outputs the work assistance information shown by the output data file to the I/F unit 107 (step ST16). As a result, the worker can recognize the work assistance information visually, auditorily, or visually and auditorily via the speaker SP, the display device 13, or both these speaker and display device.

After that, the work assistance apparatus 10 waits until receiving a predetermined response input, such as a voice or a motion pattern, which is defined in the work procedure data Fa from the worker (NO in step ST17). For example, the worker is allowed to utter “Circuit breaker A has an abnormality”, “No abnormality”, or “Next inspection.” When no predetermined response input is received even after a prescribed time period has elapsed (NO in step ST17 and YES in step ST18), the processing shifts to the next step ST20.

In contrast, when a predetermined response input is received within the prescribed time period (NO in step ST18 and YES in step ST17), the main controller 101 stores the result of the response input as an inspection result (step ST19). For example, the main controller 101 can store data showing the inspection result in the communication unit 106, or store the inspection result in an external device by transmitting the data showing the inspection result to the external device via the communication unit 106.

After that, the main controller 101 determines the presence or absence of the next work item to be inspected (step ST20). More specifically, the main controller 101 determines whether the next work item to be inspected exists by referring to the work procedure data Fa. When it is determined that the next work item to be inspected exists (YES in step ST20), the output controller 102 causes the display device 13 to perform display output of guidance information for guiding the worker to the next work item (step ST21). For example, the output controller 102 should just cause the display device 13 to display the guidance information GA shown by the arrow symbol shown in FIG. 7B. The main controller 101 then notifies the timing acquisition unit 110 of a change timing in response to the display output of the guidance information (step ST22). After that, the skill level estimation operation is performed (step ST23).

The timing acquisition unit 110 waits until being notified of a change timing. When receiving a notification of a change timing from the main controller 101, the timing acquisition unit 110 instructs the line-of-sight measuring unit 111 to perform a line-of-sight measurement, in response to the notification (step ST30 of FIG. 11). The line-of-sight measuring unit 111 measures line-of-sight information immediately after the display of the guidance information in accordance with the instruction (step ST31). The line-of-sight movement-direction measuring unit 112 calculates a measurement quantity Dm (directional measurement quantity) of a direction of line-of-sight movement on the basis of a measurement result acquired by the line-of-sight measuring unit 111 (step ST32). The line-of-sight movement-direction measuring unit 112 can calculate a directional measurement quantity Dm which is an angle or a vector quantity on the basis of an amount of change of line-of-sight coordinates calculated by the line-of-sight measuring unit 111. Further, the line-of-sight movement-timing measuring unit 113 calculates a measurement value (timing measurement value) Tm of a timing at which a line-of-sight movement of the worker starts on the basis of a measurement result acquired by the line-of-sight measuring unit 111 (step ST33). The set of these directional measurement quantity Dm and timing measurement value Tm is supplied to the skill-level estimator 114. The steps ST32 and ST33 do not have to be performed in this order, and can be alternatively performed in reverse order or performed simultaneously in parallel.

After that, the skill-level estimator 114 accesses the storage medium 105 to acquire the reference data file Fc (step ST34). Then, with respect to the similarity k set in the reference data file Fc, the skill-level estimator 114 compares the set (Dm, Tm) of the measurement quantity Dm and the measurement value Tm with the set (Dₖ, Tₖ) of the directional reference quantity Dₖ and the timing reference value Tₖ which corresponds to the skill level k (steps ST35 to ST37).

Concretely, the skill-level estimator 114 sets a number k indicating a skill level (k is an integer ranging from 1 to Q) to “1” first (step ST35). The skill-level estimator 114 then compares the measurement quantity Dm with the directional reference quantity Dₖ corresponding to the skill level k and calculates either a dissimilarity ΔD(k) or a similarity SD(k) which is a result of the comparison (step ST36). For example, the skill-level estimator can calculate either the dissimilarity AD(k) or the similarity SD(k) by using the following equation (1A) or (1B) (a is a positive coefficient).

ΔD(k)=|Dm−Dₖ| (1A)

SD(k)=a/ΔD(k) (1B)

The measurement quantity Dm in the above equation (1A) is the angle which the direction shown by the guidance information forms with the direction of line-of-sight movement of the worker. The dissimilarity ΔD(k) means the absolute value of the difference between the measurement quantity Dm and the directional reference quantity Dₖ. When the measurement quantity Dm and the directional reference quantity Dₖ are vector quantities, instead of the difference absolute value in the above equation (1A), for example, the norm of the difference vector between the measurement quantity Dm and the directional reference quantity Dₖ can be calculated as the dissimilarity ΔD(k). In general, the norm of a vector is the length of the vector.

The skill-level estimator 114 also compares the measurement value Tm with the timing reference value Tₖ corresponding to the skill level k and calculates either a dissimilarity ΔT(k) or a similarity ST(k) which is a result of the comparison (step ST37). For example, the skill-level estimator can calculate either the dissimilarity ΔT(k) or the similarity ST(k) by using the following equation (b is a positive coefficient).

ΔT(k)=|Tm−Tₖ| (2A)

ST(k)=b/ΔT(k) (2B)

The dissimilarity ΔT(k) in the above equation (2A) means the absolute value of the difference between the measurement value Tm and the timing reference value Tₖ.

Next, when the number k indicating a skill level does not reach the maximum number Q (YES in step ST38), the skill-level estimator 114 increments the number k indicating a skill level by 1 (step ST39), and performs the steps ST36 and ST37.

After that, when the number k indicating a skill level reaches the maximum number Q (NO in step ST38), the skill-level estimator 114 estimates the skill level of the worker on the basis of either the degrees of dissimilarity ΔD(k) and ΔT(k), or the degrees of similarity SD(k) and ST(k) (step ST40).

For example, the skill-level estimator 114 can estimate, as a result of the estimation, the skill level k which minimizes the norm of the degree-of-dissimilarity vector (ΔD(k), ΔT(k)), among the skill levels 1 to Q. The skill-level estimator 114 can alternatively estimate, as a result of the estimation, the skill level k which maximizes the norm of the degree-of-similarity vector (SD(k), ST(k)), among the skill levels 1 to Q.

As an alternative, the skill-level estimator 114 can estimate, as a result of the estimation, the degree of skill k which minimizes a combined dissimilarity Δ(k) (=ΔD(k)+ΔT(k)), among the skill levels 1 to Q. The skill-level estimator 114 can alternatively estimate, as a result of the estimation, the skill level k which maximizes a combined similarity S(k) (=SD(k)+ST(k)), among the skill levels 1 to Q.

As an alternative, in the case in which only two skill levels including the skill level 1 for beginners and the skill level 2 for experts are prepared, the skill-level estimator 114 can estimate that the skill level 2 is a result of the estimation when the requirement A as shown below is satisfied, whereas the skill-level estimator can estimate that the skill level 1 is a result of the estimation when the requirement A is not satisfied.

Requirement A: ΔD(1)>ΔD(2) and ΔT(1)>ΔT(2)

After the performance of the above-mentioned step ST40, the processing returns to the step ST13 shown in FIG. 10. When finally determining that no next work item to be inspected exists (NO in step ST20), the main controller 101 ends the work assistance processing.

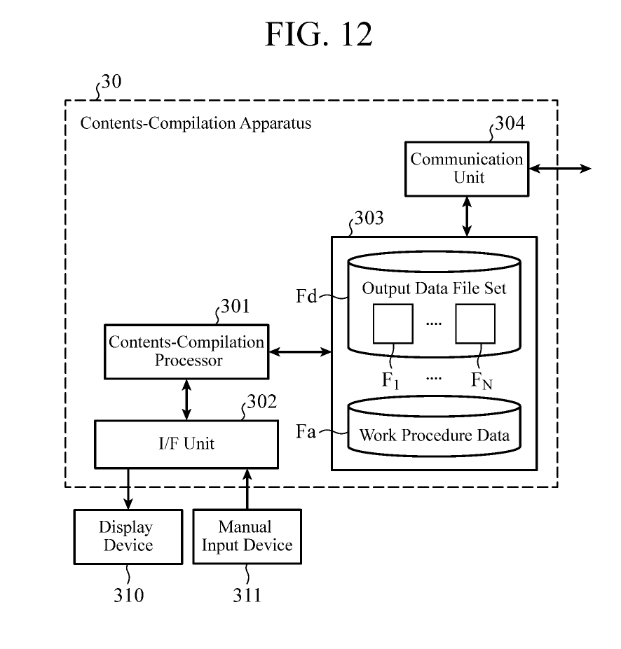

Next, the contents-compilation apparatus 30 will be explained. FIG. 12 is a block diagram showing the schematic configuration of the contents-compilation apparatus 30.

As shown in FIG. 12, the contents-compilation apparatus 30 is configured so as to include a contents-compilation processor 301, an interface unit (I/F unit) 302, a storage medium 303, and a communication unit 304. The contents-compilation apparatus 30 can be implemented by using, for example, computer equipment such as a personal computer or a workstation.

The work procedure data Fa is stored in the storage medium 303. The contents-compilation processor 301 can cause a display device 310 to display a screen image for compilation which makes it possible to compile the descriptions of the work procedure data Fa and generate the output data file set Fd, via the I/F unit 302. A compiler can compile the descriptions of the work procedure data Fa by inputting information to the contents-compilation processor 301 while visually recognizing the screen image for compilation and handling a manual input device 311, thereby generating the output data file set Fd. The output data file set Fd consists of the plural output data files F₁, . . . , F_{N} which correspond to skill levels on a multi-level scale. The communication unit 304 can communicate with the work assistance apparatus 10 to supply the output data file set Fd to the work assistance apparatus 10.

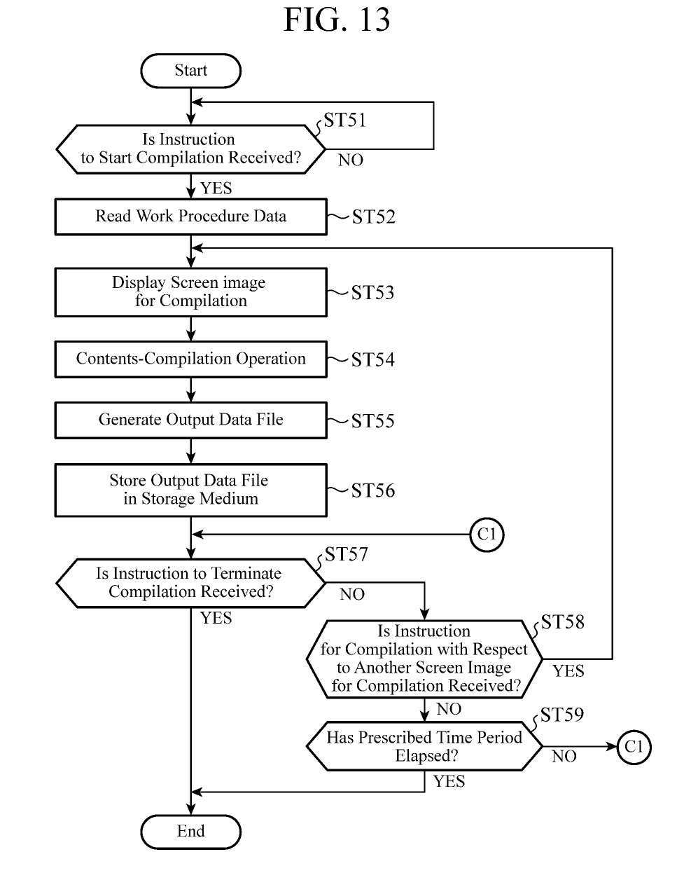

Next, the operations of the contents-compilation apparatus 30 will be explained with reference to FIG. 13. FIG. 13 is a flow chart showing an example of the procedure of output data file generating processing carried out by the contents-compilation processor 301.

The contents-compilation processor 301 waits until receiving an instruction to start compilation provided through a manual input done by the compiler (NO in step ST51). When receiving an instruction to start compilation (YES in step ST51), the contents-compilation processor 301 reads the work procedure data Fa (step ST51), and causes the display device 310 to display a screen image for compilation with respect to either a work target or one or more work items which are specified by the instruction to start compilation (step ST53). The contents-compilation processor then performs a contents-compilation operation corresponding to a manual input done by the compiler (step ST54). Through the contents-compilation operation, the user can compile the information (e.g., the contents of a text to be displayed as shown in FIG. 4) registered in the work procedure data Fa, and generate information corresponding to the skill level.

After ending the contents-compilation operation, the contents-compilation processor 301 generates an output data file corresponding to the skill level (step ST55), and stores the output data file in the storage medium 303 (step ST56).

After that, when an instruction for compilation with respect to another screen image for compilation is received in a state in which no instruction to terminate compilation is received (NO in step ST57 and YES in step ST58), the contents-compilation processor 301 performs the step ST53 and the subsequent steps. In contrast, when no instruction for compilation with respect to another screen image for compilation is received in the state in which no instruction to terminate compilation is received (NO in step ST57 and NO in step ST58), the contents-compilation processor 301 waits while this state does not last a prescribed time period (NO in step ST59). When the state lasts the prescribed time period (YES in step ST59), or when an instruction to terminate compilation is received (YES in step ST57), the above-mentioned output data file generating processing is ended.

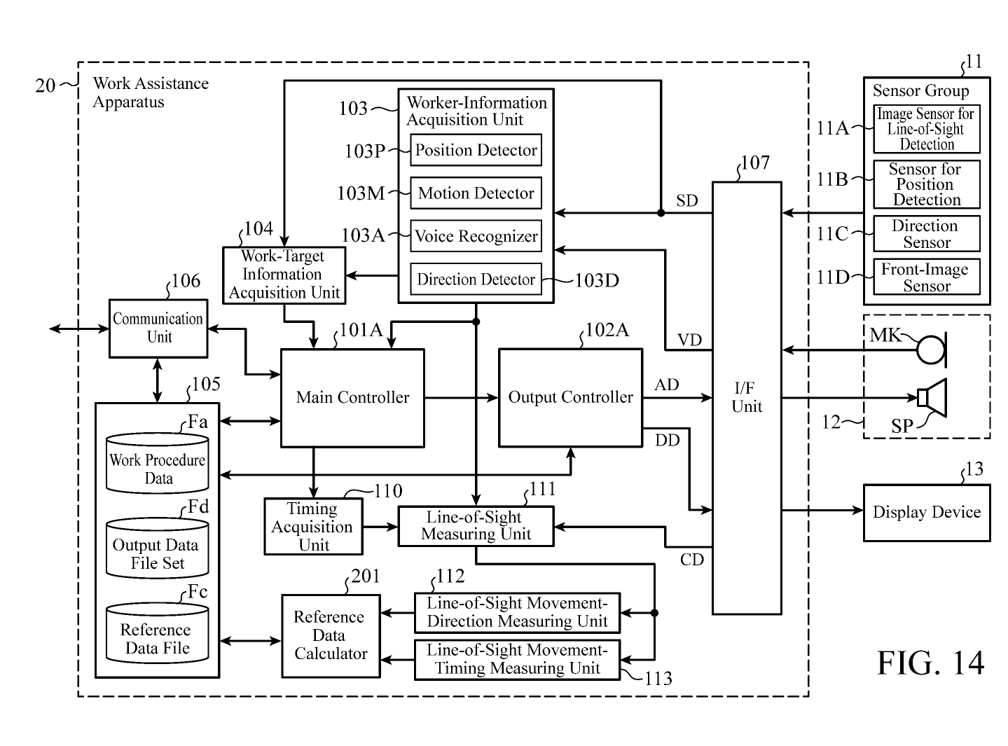

Next, the work learning apparatus 20 will be explained. FIG. 14 is a block diagram showing the schematic configuration of the work learning apparatus 20. The configuration of the work learning apparatus 20 is the same as that of the above-mentioned work assistance apparatus 10, with the exception that the work learning apparatus includes a main controller 101A, an output controller 102A, and a reference data calculator 201.

The main controller 101A has the same function as the main controller 101 of the work assistance apparatus 10, with the exception that the main controller 101A controls only the skill level that is set. Further, the output controller 102A has the same function as the output controller 102 of the work assistance apparatus 10, with the exception that the output controller 102A performs an operation on only the set skill level. More specifically, the output controller 102A acquires an output data file corresponding to the set skill level from an output data file set Fd in accordance with control performed by the main controller 101A. The output controller 102A then supplies work assistance information having descriptions shown by the output data file to a speaker SP, a display device 13, or both these speaker and display device via an I/F unit 107.

In this case, the set skill level is the known skill level of a worker who uses the work learning apparatus 20. For example, the main controller 101A can set the skill level on the basis of skill-level setting information which is input by voice to a microphone MK, by using the voice recognition function of a voice recognizer 103A. As an alternative, the skill level can be set on the basis of skill-level setting information that is input via a communication unit 106.

The reference data calculator 201 can calculate a directional reference quantity on the basis of a measurement quantity calculated by a line-of-sight movement-direction measuring unit 112. For example, the average of quantities which have been measured multiple times for one or more workers having the same skill level can be calculated as the directional reference quantity. The reference data calculator 201 can also calculate a timing reference value on the basis of a measurement value calculated by a line-of-sight movement-timing measuring unit 113. For example, the average of values which have been measured multiple times for one or more workers having the same skill level can be calculated as the timing reference value. A reference data file Fc including these directional reference quantity and timing reference value is stored in a storage medium 105. The communication unit 106 can communicate with the work assistance apparatus 10 to supply the reference data file Fc to the work assistance apparatus 10.

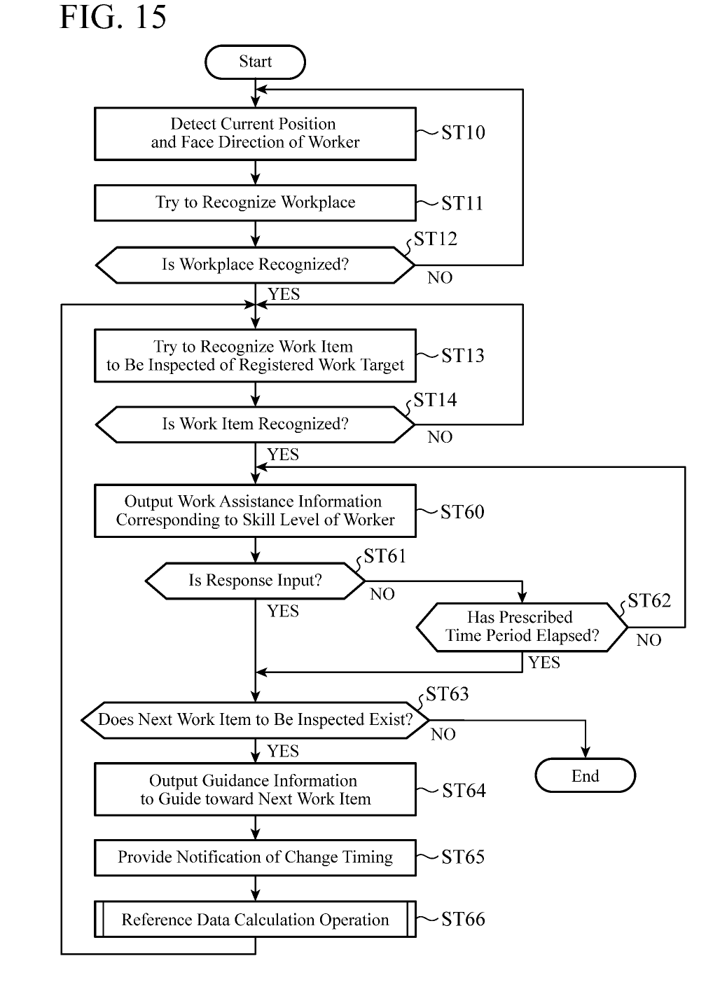

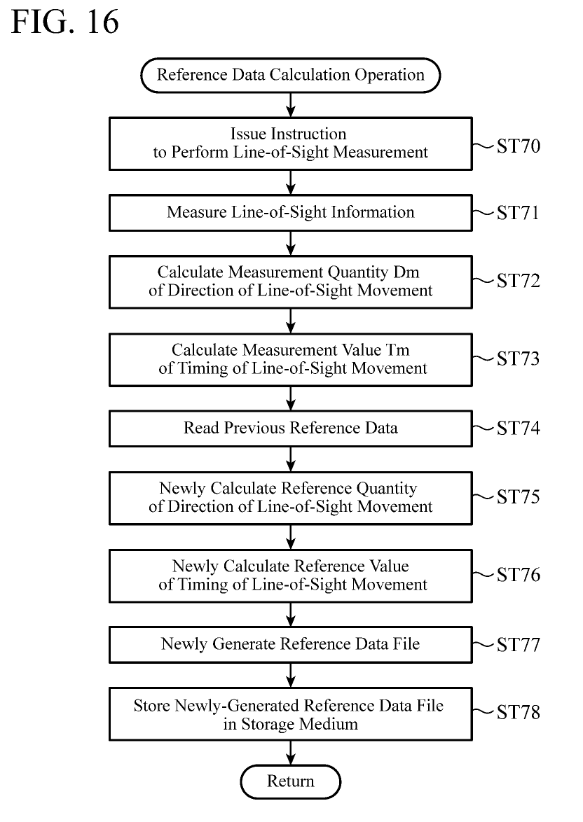

Next, the operations of the work learning apparatus 20 will be explained with reference to FIGS. 15 and 16. FIG. 15 is a flow chart showing an example of the procedure of work learning processing carried out by the work learning apparatus 20, and FIG. 16 is a flow chart showing an example of the procedure of a reference data calculation operation (step ST66) in the work learning processing shown in FIG. 15.

Referring to FIG. 15, the work learning apparatus 20 performs the same processes as those in the steps ST10 to ST14 shown in FIG. 10. After performing the step ST14, the output controller 102A accesses the storage medium 105 to select an output data file corresponding to the skill level from the output data file set Fd, and outputs the work assistance information shown by the output data file to the I/F unit 107 (step ST60). As a result, the worker can recognize the work assistance information visually, auditorily, or visually and auditorily via the speaker SP, the display device 13, or both these speaker and display device.

Next, the work learning apparatus 20 waits until receiving a predetermined response input, such as a voice or a motion pattern, which is defined in work procedure data Fa from the worker (NO in step ST61). For example, the worker is allowed to utter “Circuit breaker A has an abnormality”, “No abnormality”, or “Next inspection.” When no predetermined response input is received even after a fixed time period has elapsed (NO in step ST61 and YES in step ST62), the processing shifts to the next step ST63.

In contrast, when a predetermined response input is received within the fixed time period (NO in step ST62 and YES in step ST61), the main controller 101A determines the presence or absence of the next work item to be inspected (step ST63). When it is determined that the next work item to be inspected exists (YES in step ST63), the output controller 102A causes the display device 13 to perform display output of guidance information for guiding the worker to the next work item, like in the case of the above-mentioned step ST21 (step ST64). The main controller 101A then notifies a timing acquisition unit 110 of a change timing in response to the display output of the guidance information (step ST65). After that, the reference data calculation operation is performed (step ST66).

When receiving a notification of a change timing from the main controller 101, the timing acquisition unit 110 instructs a line-of-sight measuring unit 111 to perform a line-of-sight measurement, in response to the notification (step ST70 of FIG. 16). The line-of-sight measuring unit 111 measures line-of-sight information immediately after the display of the guidance information in accordance with the instruction (step ST71). The line-of-sight movement-direction measuring unit 112 calculates a measurement quantity Dm of the direction of line-of-sight movement on the basis of a measurement result acquired by the line-of-sight measuring unit 111 (step ST72). Further, the line-of-sight movement-timing measuring unit 113 calculates a measurement value Tm of a timing at which a line-of-sight movement of the worker starts on the basis of a measurement result acquired by the line-of-sight measuring unit 111 (step ST73). The set of these directional measurement quantity Dm and timing measurement value Tm is supplied to the reference data calculator 201. The steps ST72 and ST73 do not have to be performed in this order, and can be alternatively performed in reverse order or performed simultaneously in parallel.

Next, the reference data calculator 201 accesses the storage medium 105 to read a previous reference data file Fc (step ST74). The reference data calculator 201 then calculates, as a new directional reference quantity, the average of plural measurement quantities including a quantity which has been previously measured, on the basis of both a previous directional reference quantity in the reference data file Fc, and the measurement quantity Dm (step ST75). The reference data calculator 201 also calculates, as a new timing reference value, the average of plural measurement values including a value which has been previously measured, on the basis of both a previous timing reference value in the reference data file Fc, and the measurement value Tm (step ST76). Then, the reference data calculator 201 newly generates a reference data file by using the directional reference quantity and the timing reference value which are newly calculated (step ST77), and stores the newly-generated reference data file in the storage medium 105 (step ST78).

After performing the above-mentioned step ST66, the processing returns to the step ST13 shown in FIG. 15. When finally determining that no next work item to be inspected exists (NO in step ST63), the main controller 101 ends the work learning processing.

Each of the hardware configurations of the work assistance apparatus 10 and the work learning apparatus 20, which are explained above, can be implemented by, for example, an information processing device, such as a workstation or a mainframe, which has a computer configuration in which a CPU (Central Processing Unit) is mounted. As an alternative, each of the hardware configurations of the above-mentioned work assistance apparatus 10 and the above-mentioned work learning apparatus 20 can be implemented by an information processing device having an LSI (Large Scale Integrated circuit) such as a DSP (Digital Signal Processor), an ASIC (Application Specific Integrated Circuit), or an FPGA (Field-Programmable Gate Array).

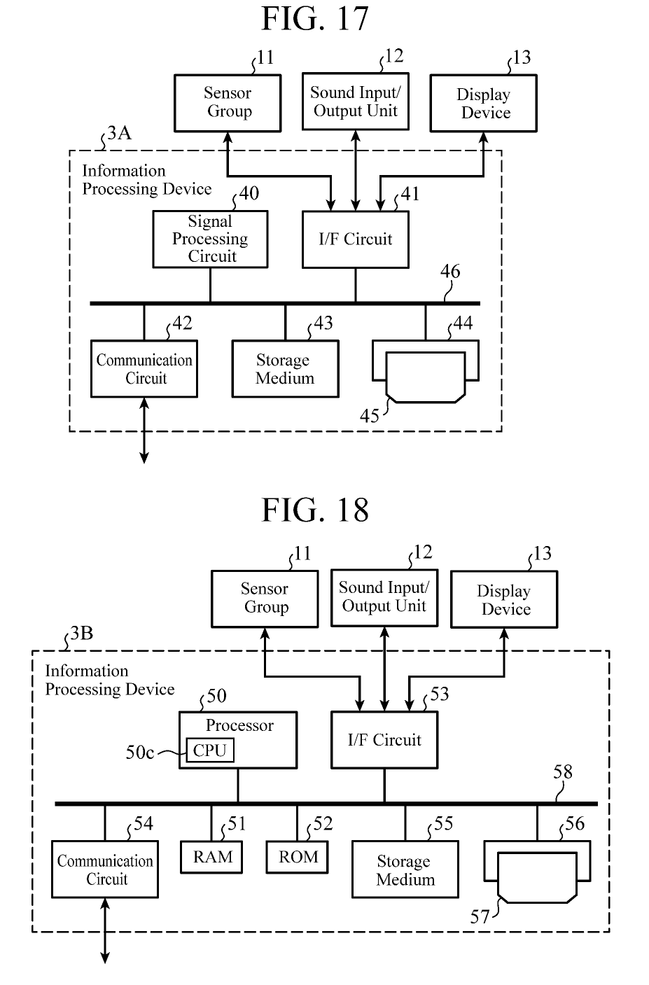

FIG. 17 is a block diagram showing the schematic configuration of an information processing device 3A which is an example of the hardware configuration of the above-mentioned work assistance apparatus 10 or the above-mentioned work learning apparatus 20. The information processing device 3A is configured so as to include a signal processing circuit 40 consisting of an LSI such as a DSP, an ASIC, or an FPGA, an interface (I/F) circuit 41, a communication circuit 42, a mounted storage medium 43, a memory interface unit 44, and a storage medium 45. These signal processing circuit 40, I/F circuit 41, communication circuit 42, storage medium 43, and memory interface unit 44 are connected to one another via a signaling channel 46 such as a bus circuit. Further, the storage medium 45 is a removable medium which is connected in a detachable manner to the memory interface unit 44.

In a case in which the work assistance apparatus 10 shown in FIG. 3 is configured using the information processing device 3A shown in FIG. 17, the main controller 101, the output controller 102, the worker-information acquisition unit 103, the work-target information acquisition unit 104, the timing acquisition unit 110, the line-of-sight measuring unit 111, the line-of-sight movement-direction measuring unit 112, the line-of-sight movement-timing measuring unit 113, and the skill-level estimator 114 can be implemented by the signal processing circuit 40 shown in FIG. 17. Further, the communication unit 106 can be configured using the communication circuit 42 shown in FIG. 17, and the I/F unit 107 can be configured using the I/F circuit 41 shown in FIG. 17. In addition, the storage medium 105 can be configured using the storage medium 43 or 45 shown in FIG. 17.

In contrast, in a case in which the work learning apparatus 20 shown in FIG. 14 is configured using the information processing device 3A shown in FIG. 17, the main controller 101A, the output controller 102A, the worker-information acquisition unit 103, the work -target information acquisition unit 104, the timing acquisition unit 110, the line-of-sight measuring unit 111, the line-of-sight movement-direction measuring unit 112, the line-of-sight movement-timing measuring unit 113, and the reference data calculator 201 can be implemented by the signal processing circuit 40 shown in FIG. 17. Further, the communication unit 106 can be configured using the communication circuit 42 shown in FIG. 17, and the I/F unit 107 can be configured using the I/F circuit 41 shown in FIG. 17. In addition, the storage medium 105 can be configured using the storage medium 43 or 45 shown in FIG. 17.

FIG. 18 is a block diagram showing the schematic configuration of an information processing device 3B which is another example of the hardware configuration of the above-mentioned work assistance apparatus 10 or the above-mentioned work learning apparatus 20. The information processing device 3B is configured so as to include a processor 50 including a CPU 50c, a RAM (Random Access Memory) 51, a ROM (Read Only Memory) 52, an interface (I/F) circuit 53, a communication circuit 54, a mounted storage medium 55, a memory interface unit 56, and a storage medium 57. These processor 50, RAM 51, ROM 52, I/F circuit 53, communication circuit 54, storage medium 55, and memory interface unit 56 are connected to one another via a signaling channel 58 such as a bus circuit. The storage medium 57 is a removable medium which is connected in a detachable manner to the memory interface unit 56. The processor 50 operates in accordance with a computer program read from the ROM 52, thereby being able to implement the functions of either the work assistance apparatus 10 or the work learning apparatus 20.

In a case in which the work assistance apparatus 10 shown in FIG. 3 is configured using the information processing device 3B shown in FIG. 18, the main controller 101, the output controller 102, the worker-information acquisition unit 103, the work-target information acquisition unit 104, the timing acquisition unit 110, the line-of-sight measuring unit 111, the line-of-sight movement-direction measuring unit 112, the line-of-sight movement-timing measuring unit 113, and the skill-level estimator 114 can be implemented by the processor 50 shown in FIG. 18 and the computer program. Further, the communication unit 106 can be configured using the communication circuit 54 shown in FIG. 18, and the I/F unit 107 can be configured using the I/F circuit 53 shown in FIG. 18. In addition, the storage medium 105 can be configured using the storage medium 55 or 57 shown in FIG. 18.

In contrast, in a case in which the work learning apparatus 20 shown in FIG. 14 is configured using the information processing device 3B shown in FIG. 18, the main controller 101A, the output controller 102A, the worker-information acquisition unit 103, the work-target information acquisition unit 104, the timing acquisition unit 110, the line-of-sight measuring unit 111, the line-of-sight movement-direction measuring unit 112, the line-of-sight movement-timing measuring unit 113, and the reference data calculator 201 can be implemented by the processor 50 shown in FIG. 18 and the computer program. Further, the communication unit 106 can be configured using the communication circuit 54 shown in FIG. 18, and the I/F unit 107 can be configured using the I/F circuit 53 shown in FIG. 18. In addition, the storage medium 105 can be configured using the storage medium 55 or 57 shown in FIG. 18.

As each of the mounted storage media 43 and 55 shown in FIGS. 17 and 18, for example, either an HDD (hard disk drive) or an SSD (solid-state drive) can be used. Further, as each of the removable storage media 45 and 57, for example, a flash memory such as an SD (registered trademark) card can be used.

Further, each of the communication circuits 42 and 54 shown in FIGS. 17 and 18 should just have a function of being able to communicate with another communication device either via a cable or in a wireless manner. Each of the communication circuits 42 and 54 can be configured so as to communicate with another communication device via, for example, a cable, a cable LAN (Local Area Network), a wireless LAN, or a wide area network such as the Internet. Further, the communication circuit 42 can have a communication function using a short-range wireless communication technique such as Bluetooth (registered trademark).

As previously explained, according to the present embodiment, because the skill level of a worker can be estimated automatically by using a measurement value of the timing of line-of-sight movement, a measurement quantity of the direction of line-of-sight movement, or both of these measured results at a time when the worker changes from an inspection item to another inspection item, the skill level can be estimated promptly even though the worker performs work accompanied by his or her motion. Therefore, by presenting work assistance information having descriptions corresponding to the skill level of the worker to the worker by using the result of the estimation, effective work assistance can be provided for the worker. Further, when the worker 4 performs work while attaching the wearable device 5 equipped with spectacles, like in the case of the present embodiment, there occurs a state in which a line-of-sight movement resulting from a motion of the worker 4 easily occurs. Even in such a state, according to the present embodiment, because the skill level of the worker can be estimated automatically by using the measurement value of the timing of line-of-sight movement, the measurement quantity of the direction of line-of-sight movement, or both of these measured results at a time when the worker changes from an inspection item to another inspection item, there is provided an advantage of improving the accuracy of the estimation of the skill level. Even when, instead of the wearable device 5 equipped with spectacles of the present embodiment, another type of wearable device is used, the same advantage can be provided.

Further, as mentioned above, the output controller 102 of the work learning apparatus 20 selects an output data file corresponding to the skill level estimated by the skill-level estimator 114, from among the output data files F₁ to F_{N} corresponding to plural skill levels. A compiler can compile each of the output data files F₁ to F_{N} by using the contents-compilation apparatus 30. With this configuration, the descriptions of the work assistance information can be customized in detail with flexibility in accordance with the skill level, and the working efficiency of the worker 4 can be improved.

Although Embodiment 1 according to the present invention has been described with reference to the drawings as previously explained, the embodiment exemplifies the present invention, and various embodiments other than the embodiment can also be exemplified. Within the scope of the present invention, an arbitrary combination of two or more of the components of the above embodiment can be made, a change can be made in an arbitrary component of the above embodiment, and/or an arbitrary component of the above embodiment can be omitted.

### INDUSTRIAL APPLICABILITY

The work assistance apparatus and the work assistance system according to the present invention can be applied to assistance in work, such as maintenance or inspection of machinery and equipment, or repair or assembly of machinery and equipment, which is performed in accordance with a certain procedure.

### REFERENCE SIGNS LIST

1: work assistance system; 2: work assistance system; 3A, 3B: information processing devices; 4: worker; 5: wearable device equipped with spectacles; 10: work assistance apparatus; 11: sensor group; 11A: image sensor for line-of-sight detection; 11B: sensor for position detection; 11C: direction sensor; 11D: front-image sensor; 12: sound input/output unit; 13: display device; 13V: eyeglass portions; 20: work learning apparatus; 30: contents-compilation Apparatus; 40: signal processing circuit; 41: interface (I/F) circuit; 41: I/F circuit; 42: communication circuit; 43: storage medium; 44: memory interface; 45: storage medium; 46: signal path; 50: processor; 51: RAM; 52: ROM; 53: interface (I/F) circuit; 54: communication circuit; 55: storage medium; 56: memory interface; 57: storage medium; 58: signal path; 101, 101A: main controllers; 102, 102A: output controller; 103: worker-information acquisition unit; 103P: position detector; 103M: motion detector; 103A: voice recognizer; 103D: direction detector; 104: work-target information acquisition unit; 105: storage medium; 106: communication unit; 107: interface unit (I/F unit); 110: timing acquisition unit; 111: line-of-sight measuring unit; 112: line-of-sight movement-direction measuring unit; 113: line-of-sight movement-timing measuring unit; 114: skill-level detector; 201: reference data calculator; 301: contents-compilation processor; 302: interface unit (I/F unit); 303: storage medium; 304: communication unit; 310: display device; and 311: manual input device.

1. A work assistance apparatus comprising:
a processor to execute a program; and
a memory to store therein the program which, when executed by the processor, causes the processor to perform operations including:
causing an information output unit to output display of guidance information that prompts a worker to move a line of sight toward a next work item to be inspected from an inspected work item;
starting measuring line-of-sight information about the worker; in response to the output of the display of guidance information;
measuring a direction of line-of-sight movement on a basis of a measurement result acquired by the measurement of the line-of-sight information, thereby to output a measurement quantity of the direction of line-of-sight movement;
comparing the measurement quantity with a reference quantity prepared in advance; estimating a skill level indicating a proficiency level of the worker on a basis of a result of the comparison; and
causing the information output unit to output work assistance information having descriptions corresponding to the estimated skill level.

2. (canceled)

3. The work assistance apparatus according to claim 1, wherein: the operations further include measuring a timing at which a line-of-sight movement starts on a basis of a measurement result acquired by the measurement of the line-of-sight information thereby to output a measurement value of the timing; and
the skill level is estimated on a basis of a combination of a comparison result acquired by comparing the measurement quantity with the reference quantity, and a comparison result acquired by comparing the measurement value with a reference value prepared in advance.

4. The work assistance apparatus according to claim 1, wherein; the operations further include selecting an output data file corresponding to the estimated skill level from among plural output data files corresponding to respective skill levels; and
the work assistance information, is represented by the selected output data file.

5. The work assistance apparatus according to claim 1, wherein the information output unit composes a part of a wearable device attached to a head or body of the worker.

6. A work assistance apparatus comprising:
a processor to execute a program; and
a memory to store therein the program which, when executed by the processor, causes the processor to perform operations including:
causing an information output unit to output display of guidance information that prompts a worker to move a line of sight toward a next work item to be inspected from an inspected work item;
measuring line-of-sight information about the worker in response to the display output of the guidance information;
measuring a timing at which a line-of-sight movement starts on a basis of a measurement result acquired by the measurement of the line-of-sight information, thereby to output a measurement value of the timing;
comparing the measurement value with a reference value prepared in advance;
estimating a skill level indicating a proficiency level of the worker on a basis of a result of the comparison; and
causing the information output unit to output work assistance information having descriptions corresponding to the estimated skill level.

7. The work assistance apparatus according to claim 6, wherein:
the operations further include selecting an output data file corresponding to the estimated skill level from among plural output data files corresponding to respective skill levels; and
the work assistance information is represented by the selected output data file.

8. The work assistance apparatus according to claim 6, wherein the information output unit is a part of a wearable device attached to a head or body of the worker.

9. A work learning apparatus comprising:
a processor to execute a program; and
a memory to store therein the program which, when executed by the processor, causes the processor to perform operations including:
causing an information output unit to output display of guidance information that prompts a worker to move a line of sight toward a next work item to be inspected from an inspected work item;
measuring line-of-sight information about the worker in response to the output of display of the guidance information;
measuring a direction of line-of-sight movement on a basis of a measurement result acquired by the measurement of the line-of-sight information, thereby to output a measurement quantity of the direction of line-of-sight movement; and
calculating a reference quantity corresponding to the guidance information on a basis of the measurement quantity.

10. Currently Amended) A work assistance system comprising:
the work assistance apparatus according to claim 1; and
a work learning apparatus which includes a processor to execute a program, and a memory to store therein the program which, when executed by the processor, causes the processor to perform operations including:
causing an information output unit to output display of guidance information that prompts a worker using the work learning apparatus to move a line of sight toward a next work item to be inspected from an inspected work item;
measuring line-of-sight information about the worker using the work learning apparatus, in response to the output of display of the guidance information that prompts the worker using the work learning apparatus;
measuring a direction of line-of-sight movement for work learning on a basis of a measurement result acquired by the measurement of the line-of-sight information about the worker using the work learning apparatus, thereby to output a measurement quantity of the direction of line-of-sight movement measured for work learning; and
calculating the reference quantity corresponding to the guidance information that prompts the worker using the work learning apparatus, on a basis of the measurement quantity of the direction of line-of-sight movement measured for work learning.
